(19) United States
(12) Patent Application Publication
(10) Pub. No.: US 2024/0252991 A1
(43) Pub. Date: Aug. 1, 2024

(54) CROWN ETHER MODIFIED CATION EXCHANGE MEMBRANES FOR SELECTIVE RECOVERY OF IONIC SPECIES AND METHODS OF MAKING AND USING THE SAME

(71) Applicant: UCHICAGO ARGONNE, LLC, Chicago, IL (US)

(72) Inventors: Feng Gao, Bolingbrook, IL (US); Yuepeng Zhang, Naperville, IL (US); Lei Cheng, Naperville, IL (US); Shi Li, Naperville, IL (US); Seth B. Darling, Chicago, IL (US); Lu Zhang, Naperville, IL (US); Lily A. Robertson, Chicago, IL (US)

(21) Appl. No.: 18/429,019

(22) Filed: Jan. 31, 2024

Related U.S. Application Data
(60) Provisional application No. 63/482,578, filed on Jan. 31, 2023.

(51) Int. Cl. B01D 69/12; B01D 61/46; B01D 71/60

(52) U.S. Cl. CPC B01D 69/125; B01D 61/463; B01D 71/60

(57) ABSTRACT

A membrane for selective separation of a target cation from a source liquid containing the target cation and one or more competing ionic species can include a crown ether polymer layer disposed on a cation exchange membrane. The crown ether polymer layer can include a crown ether capable of selectively binding the target cation and a polymer.

### CROSS-REFERENCE TO RELATED APPLICATION

The benefit of priority to U.S. Provisional Patent Application No. 63/482,578 filed Jan. 31, 2023, is hereby claimed and the disclosure is incorporated herein by reference in its entirety.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates to membranes having a crown ether modified cation exchange membrane for the selective recovery of ionic species from a source liquid and methods of using the same.

### BACKGROUND

Consumption of lithium is projected to increase significantly, with an estimated 498,000 tons by the year 2025, nearly doubling the consumption in 2015. This sharp increase in lithium demand is predominantly due to the extensive use of Li-ion batteries for electronic devices. Currently, the main sources of lithium supply are brine deposits and lithium ores, which amounts to 34 million tons worldwide. While these lithium reserves are sufficient to support current market demand, the conventional lithium extraction technologies are operationally inefficient or difficult to meet future demand.

Li extraction techniques currently include Li selective sorbents such as ion-imprinted polymers, molecular sieve ion-exchange resins and intercalates (e.g., MnOₓ, TiOₓ, AlOH), solvent separation (e.g., crown ethers, cyclic siloxane, ionic liquids), lithium precipitation (e.g., AlCl₃ and NaAlO₂), reverse osmosis membranes, and selective electrodialysis. The performance of these technologies varies. In general, adsorption methods show relatively high Li selectivity, but require pretreatment and regeneration. Pressure driven membranes are energy-intensive and have low Li selectivity.

### SUMMARY

Membranes in accordance with the disclosure include a crown ether polymer layer disposed on a cation exchange membrane to provide a highly selective membrane for capturing target cations, with efficient transport of the captured cations to a product stream. Thereby providing a separation method that is highly selective to the target cation, without requiring pretreatment and regeneration.

Membranes and methods of the disclosure can allow for lithium extraction from unconventional sources, such as seawater, industry processed waters, gas and oilfield processed waters, geothermal brines, or liquids generated from battery recycling. Lithium reserves in seawater are estimated to be 230 billion tons. Additionally, water produced as the byproduct of oil and gas extraction also has recoverable amount of lithium (e.g., 10 to 100 mg/L) and 10.6 billion liters/day of such wastewater has been produced in the U.S. as of 2017. The membranes of the disclosure have been found to advantageously allow for the separation of Li⁺ from other competing monovalent ions such as Na⁺ and K⁺, thereby making efficient recovery of lithium from these unconventional sources possible on a commercially relevant scale.

A membrane for selective separation of a target cation from a source liquid containing the target cation and one or more competing ionic species can include a crown ether-based layer disposed on a cation exchange membrane. The crown ether-based layer comprises a crown ether-based building block capable of selectively binding the target cation. The crown ether-based building block is present in the crown ether-based layer in an amount of about 5 wt % to about 100 wt %.

A system for selective separation of a target cation from a source liquid containing the target cation and one or more competing ionic species includes an anode, a cathode, an anion exchange membrane, and the membrane of the disclosure interposed between the anode and the cathode that has a cathode facing side and an oppositely disposed anode facing side, wherein the crown ether-based layer is at the anode facing side and the cation exchange membrane is at the cathode facing side. Upon application of an electric field, the bound target cations are transported through the crown ether-based layer and the cation exchange membrane into a product stream. The system can further include one or more anion exchange membranes and one or more cation exchange membranes with or without crown ether-based layer.

A method for selective separation of a target cation from a source liquid containing the target cation and one or more competing ionic species can include flowing the source liquid through the system of the disclosure, between the anion exchange membrane and the crown ether-based layer of a membrane of the disclosure. The source liquid can flow through the source compartment and tangentially to the anion and crown ether-based cation membranes. The method further includes flowing a product stream through the system, between the cation exchange membrane and the cathode. The product stream can flow tangentially to the cation exchange membrane. An electric field is applied between the anode and the cathode, which drives target cations from the source liquid to the membrane. Target cations in the source liquid are selectively bound by the crown ether-based layer and transport through the crown ether-based layer and the cation exchange membrane into the product stream for recovery of the target cations. When more than one anion and cation exchange membranes are used, source water, water, and product stream can flow through their own compartment and tangentially to the membranes mounted at both sides of the compartment. Electrode solutions are also introduced to rinse the electrode and balance the pH of the electrode compartment.

### BRIEF DESCRIPTION OF THE DRAWINGS

FIG. 1A is a schematic illustration of an electrodialysis system that contains the selective cation exchange membrane in accordance with the disclosure, showing a one-cell system.

FIG. 1B is a schematic illustration of an electrodialysis system that in accordance with the disclosure, showing a two-cell system.

FIG. 1C is a schematic illustration of an electrodialysis system in accordance with the disclosure, showing a three-cell system.

FIG. 2A is a synthesis route to prepare dibenzo-14-crown-4 ether, di(nitrobenzo)-14-crown-4 ether, and di(aminobenzo)-14-crown-4 ether.

FIG. 2B is 1H Nuclear Magnetic Resonance (NMR) spectroscopy of dibenzo-14-crown-4-ether, di(nitrobenzo)-14-crown-4 ether, and di(aminobenzo)-14-crown-4 ether.

FIG. 2C is Gas Chromatography/Mass Spectrometry (GC/MS) data of dibenzo-14-crown-4 ether.

FIG. 3A is an illustration describing synthesis of a polymer precursor using a typical free radical polymerization method (middle step) and synthesis of polymer product with crown ether pendant group using oxirane opening reaction in accordance with the disclosure.

FIG. 3B are example building block structures for use in a crown ether-based polymer layer in accordance with the disclosure.

FIG. 4A is an illustration showing a typical Tröger's base polymerization to synthesize PIM-crown ether-TB with crown ether in the backbone in accordance with the disclosure. 1H NMR was measured for the synthesized PIM-DB14C4-TB.

FIG. 4B is an alternative building block for use in the synthesis route of FIG. 4A, the Di(amino)-triptycene, as an example of increasing the free volume size of a PIM-crown ether polymer layer.

FIG. 5 is an illustration of a synthesis route for forming a crown ether-based polymer layer through interfacial polymerization, showing a specific example of synthesizing a polyamide with crown ether in the backbone on top of a cation exchange membrane.

FIG. 6A is a graph showing binding energies between monovalent metal ions and different crown ether compounds suggesting stronger binding selectivity of Li by DB14C4 than Na or K. The binding energy calculation is based on an implicit water model of Density Functional Theory (DFT).

FIG. 6B is a schematic of trajectories extracted from Molecular Dynamics (MD) simulation showing the Lit transfer between two crown ether molecules under a constant external force.

FIG. 6C depicts desolvation of hydrated Lit, Nat, and K⁺ when they bind with DB14C4 molecules. The binding energy calculated using classic MD with an explicit water model indicates that only the binding of Lit is energetically favorable.

FIG. 7 is a SEM image of a DB14C4 film deposited Nafion 212 cation exchange membrane using electrospraying technology.

FIG. 8A is comparative analysis of the FTIR spectra of pure DB14C4 and DB14C4-Li⁺ complex (molar ratio of DB14C4:Li⁺=1:1) in the range of 1600-800 cm-1.

FIG. 8B is an enlarged region of the FTIR spectra in FIG. 8A with the wavenumber range of 1300-1150 cm⁻¹.

FIG. 8C is an enlarged region of the FTIR spectra in FIG. 8A with the wavenumber range of 1000-900 cm⁻¹.

### DETAILED DESCRIPTION

Membranes of the disclosure include a crown ether (CE)-based layer disposed on a cation exchange membrane (CEM). The CE-based layer includes a CE-based building block capable of selectively binding the target cation. The CE-based building block can form the crown either-based layer on top of a CEM through thin film deposition techniques like electrospray. The CE-based building block can also be chemically bound to a polymer, for example, as pendant side group or as part of the polymer backbone. Membranes of the disclosure can be used to selectively bind a target cation from a source liquid containing the target cation and one more competing ionic species. Membranes of the disclosure operate to selectively bind the target cation as the source liquid flows through the compartment and tangentially to the CE-based layer (also known as crossflow). The CEM can then transport the captured cations away from the CE-based layer under an electric field. This can allow continuous or substantially continuous cation extraction from the source liquid.

The membranes of the disclosure can be used in a system to selectively capture a target cation from a source liquid. The system can include an anode, a cathode, an anion exchange membrane (AEM), and a membrane in accordance with the disclosure disposed between the anode and the cathode. During an electrodialysis process, the target cations are selectively captured by the crown ether-based layer from the source liquid and transported through the CEM for recovery.

For example, a system in accordance with the disclosure can include one or more cells arranged between the cathode and anode. Each of the one or more cells includes an anion exchange membrane and a membrane for separation of the one or more target cations in accordance with disclosure having the CE-based layer. The membrane has a cathode facing side and an oppositely disposed anode facing side. The CE-based layer is at the anode facing side and the anion exchange membrane is arranged between the anode facing side and the anode. The system further includes a terminal anion exchange membrane arranged between the last one of the one or more cells at a cathode end of the system and the cathode; and a terminal cation exchange membrane arranged between the terminal anion exchange membrane and the cathode.

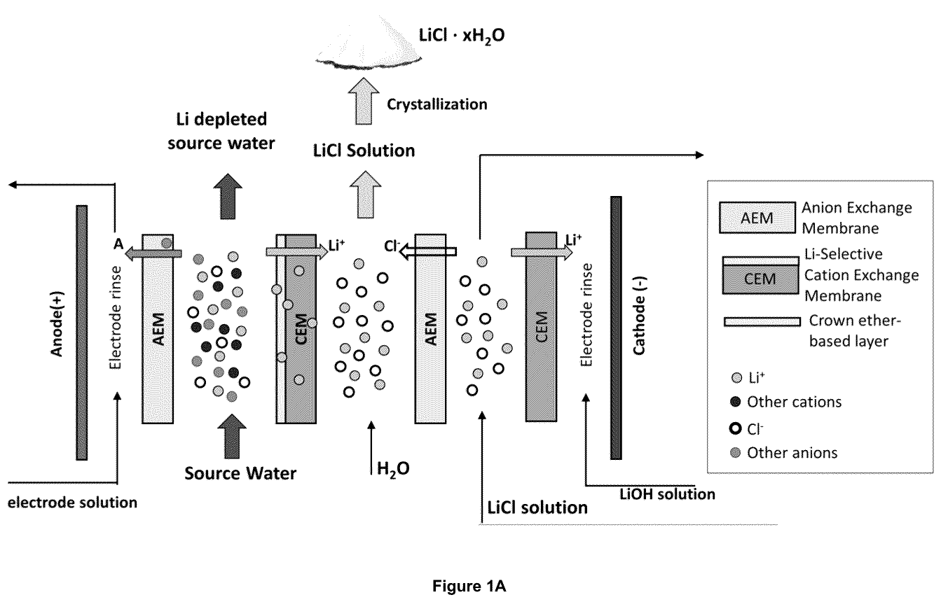

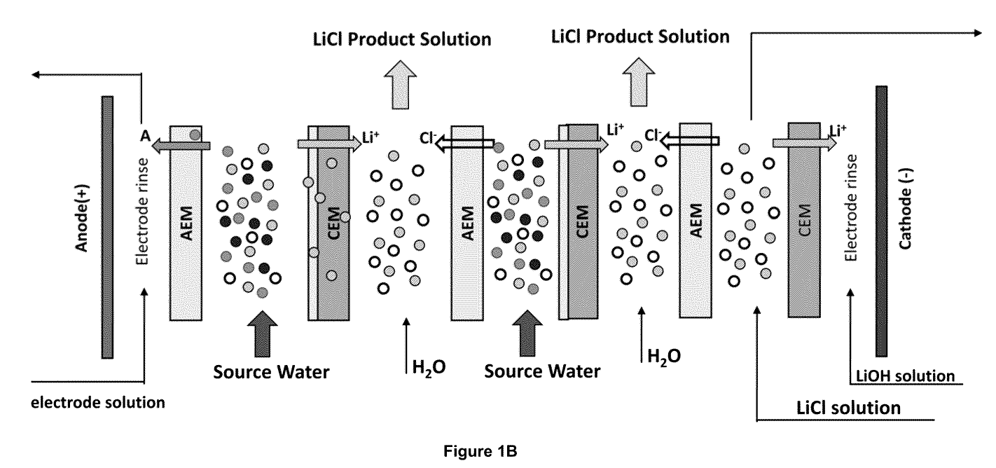

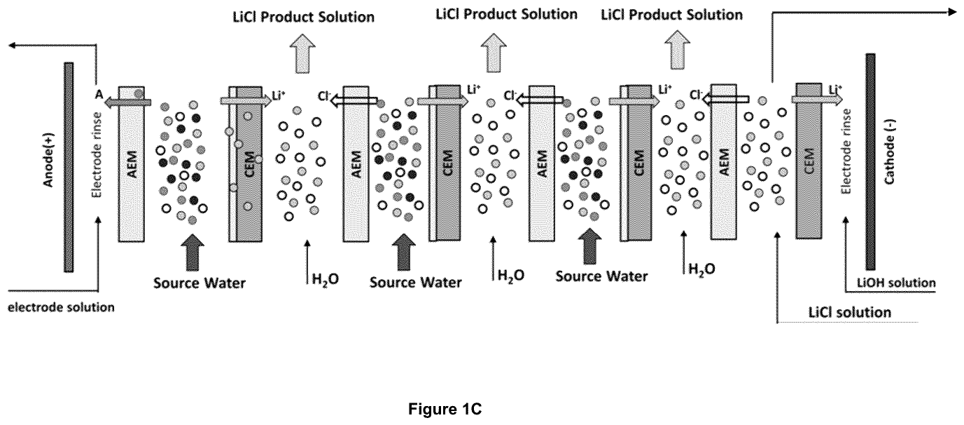

For example, as shown in FIG. 1A, the system can include a single cell, which can include the membrane in accordance with the disclosure arranged between two anion exchange membranes, the anion exchange member on the cathode facing side of the membrane of the disclosure being the terminal anion exchange membrane. The cell can further include a terminal cation exchange membrane without a CE-based layer arranged between the terminal anion exchange membrane on the cathode face side of the membrane of the disclosure and the cathode. Because a single salt solution is used to flux the channel between the terminal anion exchange membrane and terminal cation exchange membrane to introduce anions to the product stream for pH balance purpose (for example LiCl is the flux solution to supply Cl⁻ in FIG. 1), a regular cation exchange membrane can be used as terminal cation exchange membrane. Referring to FIGS. 1B and 1C, the systems of the disclosure can be multi-cell systems. In the multi-cell system, the cells, which include an anion exchange membrane and a membrane of the disclosure, are arranged between the anode and a terminal anion exchange membrane and cation exchange membrane at the cathode side of the system.

Referring to FIGS. 1A to 1C, a schematic showing selective transport of a target cation through a CE-based layer deposited on a CEM in an electrodialysis process is shown. For example, the target cation can be Lit. The CE-based layer can include pure CE-based building blocks, or a polymer comprising a CE-based building block. This CE-containing polymer generally includes the CE-based building block (i) as pendant groups (side chains) covalently bound to the polymer, or (ii) bound into the backbone. The membrane of the disclosure having the CE-based layer disposed on the CEM is arranged between the source liquid and a product stream, each flowing tangentially to the membrane. The CE-based layer is on the side of the membrane that faces the anode and is in contact with the source solution directly. The CEM is on the cathode facing side contacting the product stream directly. Under the effect of an electric field, target cations in the source solution migrate towards the product stream. The target cations are first captured by the CE-based layer and then transported through the membrane to the product stream. To achieve target cation ion transport, the electrodialysis can be operated at a constant current density that is below or equivalent to the limiting current density to de-complex the target cation from its host crown ether. Alternatively, a pulsed electrical field can be used, which can provide a larger driving force or lead to reduced concentration polarization and thus enhance mass transport of ions. The target ions can be transported out of the system for recovery due to the tangential flow of the product stream. For example, the salt solution of the target ions can be crystallized to form high-purity salt product.

This process can be operated under a constant current density between 3-75 mA cm⁻².

FIGS. 1A to 1C show a specific embodiment in which, the source liquid contains mixed cations and anions including Lit, and the product stream is a concentrated solution with higher concentration of Lit due to CE-CEM membrane extraction of Lit from source to product streams. Due to an effect of electric field, cations and anions migrate towards the oppositely charged electrode through CEM and anion exchange membrane. As a highly Li⁺ selective 14-crown-4 ether-based layer is deposited on the CEM, the CE-CEM selectively transport Lit from source to product stream in a high ionic flux, resulting in a high Li⁺ recovery in the product solution. A second set of CEM and AEM are installed to supply Cl⁻ to the product stream to neutralize charges. LiCl solution can be introduced in between the second set of CEM and AEM as the source of Cl⁻. Excess Li⁺ is transported to the cathode compartment and rinsed away by the electrode rinsing solution like LiOH. This method can also yield high Li⁺ selectivity when there is presence of competitive cations such as Nat, K⁺, and Mg²⁺. This figure is by way of example only. Other cations of interest and competing species can be separated using the membranes and methods of the disclosure.

The system can further include two or more AEMs and CEMs. For example, a system can also include two AEMs, one arranged between the anode and the CE-based layer, and the other arranged between the CEM comprising the CE-based layer and another CEM that separates this AEM from the cathode, as shown in FIG. 1. As another example, multiple sets of the system in FIG. 1 can be assembled in stacks to increase the production yield.

The flow rate of source liquid can be controlled between 0.1-150 L hr⁻¹ depending on the membrane size. The flow rate of product water can be in the same range or lower to obtain concentrated salt solution of the target ions.

The target cation(s) can be, for example, an alkali metal cation. For example, the target cation can be divalent or monovalent. For example, the membrane, system, and methods can be designed for selectively capturing one target cation from the source liquid or can be designed for selectively capture of two or more target cations from the source liquid. In embodiments in which two or more target cations are to be selectively captured, the CE-based layer can include two or more types of CE building blocks of varying cavity sizes, each capable of selective capture of one of the target cations, with preferential uptake of that target cation over other target cations as well as competing ionic species. Alternatively, more than one CE-deposited CEMs can be used in the system in sequence to extract more than one target ions in sequence.

The target cation(s) can include, for example, alkali metal such as one or more of Li⁺, Na⁺, K⁺, Rb⁺, Cs⁺, and/or transition metal ions such as one or more of Ni²⁺, Co²⁺, Fe²⁺, and/or rare earth metal ions such as one or more of Nd³⁺, Sm³⁺, Dy³⁺, Tb³⁺, Ho³⁺, Gd³⁺, and/or other cations such as one or more of NH₄₊, Ag⁺, Au³⁺, Pt²⁺, Pt⁴⁺, Ir²⁺, Ir⁴⁺, Ca²⁺, Sr²⁺, Ba²⁺, Hg²⁺, and Pb²⁺. In a source liquid having Li⁺ as the target cation, competing Na⁺, and/or Mg²⁺, and/or K⁺ ions may be present. The membranes, systems, and methods of the disclosure can be capable of selectivity capturing Li⁺ over such competing ions for such source liquids.

Crown ethers are a class of ligands known to bind various cations depending on the relative size of their cavity and the size of the target ion as well as the molecular structure of CE rings. Common crown ethers, such as 12-crown-4, 15-crown-5, and 18-crown-6 are known to bind strongly with Li⁺, Na⁺, and K⁺, respectively. It has been observed that selection of a crown ether with an appropriate cavity size, a target ion can be selectively and exclusively captured. For example, 12-crown-4 (12C4) forms reversible complexes with both Na⁺ and Li⁺, where the relative affinity depends on the chemical environment. As a result, selective complexing of a target ionic species, such as Li⁺ from other competitive metal ions could be achieved by appropriate selection of the crown ethers. Conventional use of crown ethers has been in liquid extraction methods. As compared to such methods, membranes of the disclosure are compact, modular, easy to standardize, and avoid expansive organic solvents. The membranes can allow for high target cation recovery rates and liquid treatment throughput.

Within the CE families, 12-15 membered ligands have been found to form stable Li⁺ complexes in the presence of other alkali metal ions. For example, dibeno-14-crown-4 (DB14C4) and its derivatives such as di(nitrobenzo)-14-crown-4 and di(aminobenzo)-14-crown-4 have been shown to bind Li⁺ selectively because their cavity sizes and the shift of binding energy due to two benzene rings or increased C2 to C3 segment are favorable to Li⁺ binding.

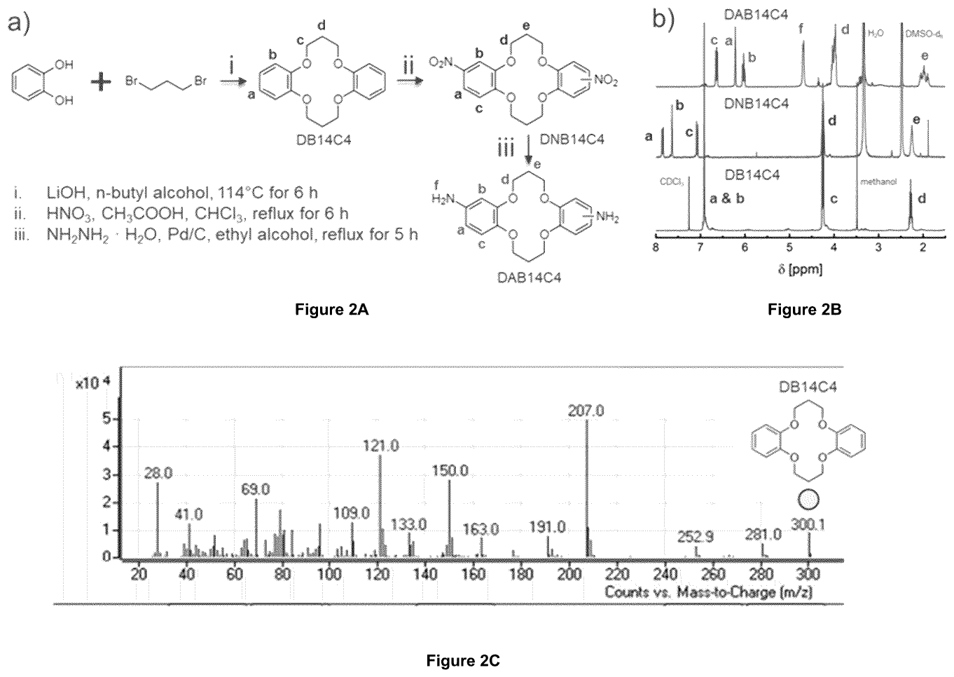

CE derivatives can be synthesized via different chemical reaction pathways. For example, DB14C4 can be synthesized based on nucleophilic substitution reaction between pyrocatechol and 1,3-dibromopropane using LiOH as a template. DNB14C4 can be synthesized by nucleophilic substitution reaction catalyzed by nitric acid. DAB14C4 can be synthesized based on the catalytic hydrogeneration of DNB14C4 using palladium on carbon as catalyst. FIG. 2A and FIG. 2B show the synthesis routes for DB14C4, DNB14C4 and DAB14C4 preparation, and the ¹H NMR spectrum of each monomer. FIG. 2C shows GC/MS measurement of DB14C4, which indicates the molecular weight of DB14C4 is about 300.1 g mol-.

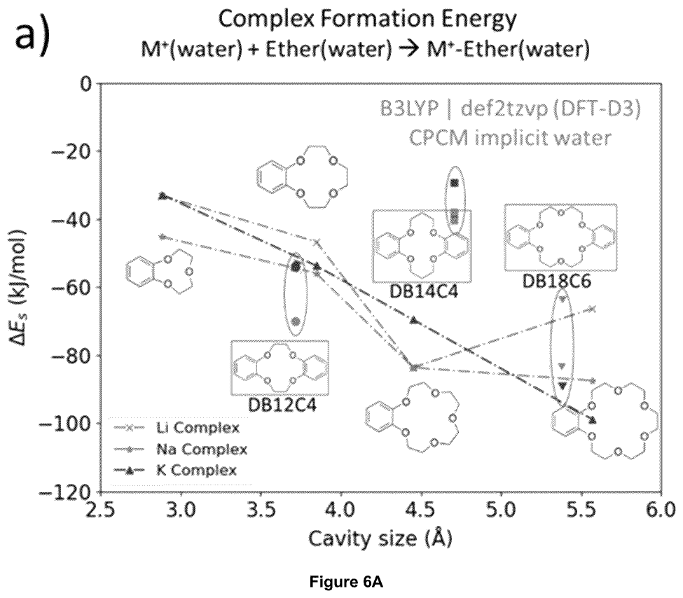

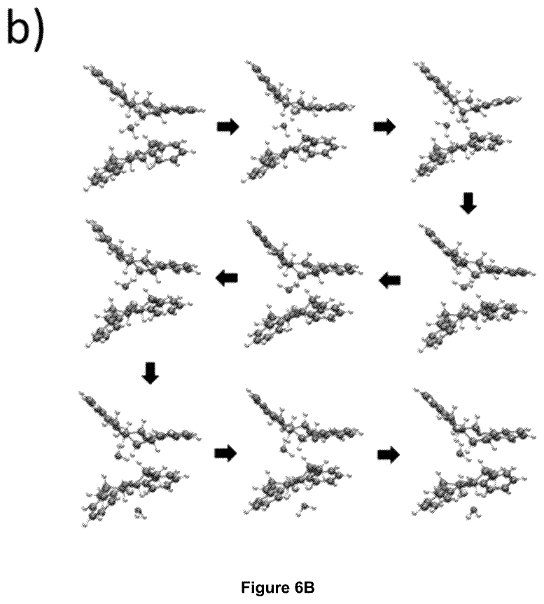

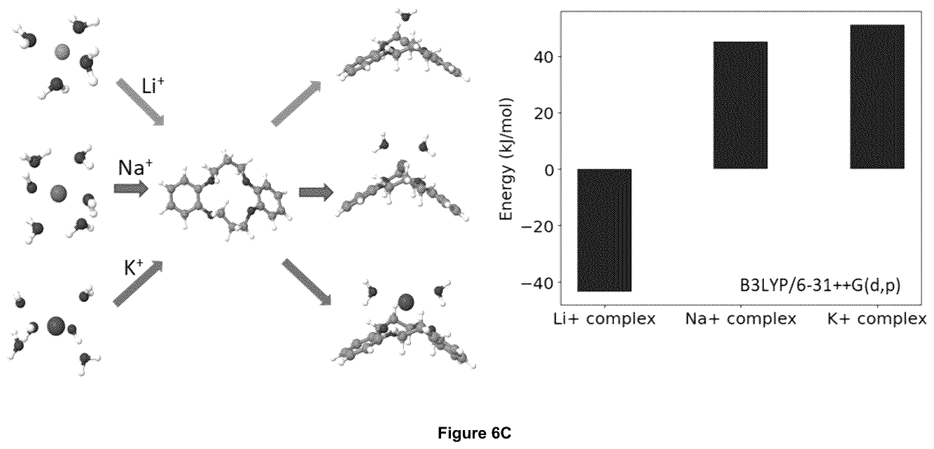

Selection of the CE-based building blocks can be made based on the target cation(s) to be captured. The CE-based building block can be, for example, an amino-crown ether. Examples of amino-crown ethers include aminobenzo-12-crown-4, aminobenzo-14-crown-4 ether, di(aminobenzo)-14-crown-4 ether, aminobenzo-15-crown-5 ether, di(aminobenzo)-15-crown-5 ether, aminobenzo-18-crown-6 ether, di(aminobenzo)-18-crown-6 ether, aminoben-24-crown-8 ether, di(aminobenzo)-24-crown-8 ether, and derivatives thereof. For example, the CE-based building block can be or include heteroatom CE where oxygens on the CE are replaced with nitrogen or sulfur, hydroxyl (—OH) or alkylates (—CH(CH₂)ₙCH₃ attached on the CE). The CE can include one or more side groups. The side groups can be selected to tune the selectivity and/or capture rate of the CE for the target ions. For example, preliminary computation study showed that the binding of Li⁺, Na⁺, and K⁺ to CE generally becomes more favorable (more negative binding energy) with increasing ring and cavity size, as indicated by the data lines in FIG. 6A for the series of structures with one benzene ring and increasing C₂O ether unit. However, other molecular structure modification strategies to restrict the ring rotation and/or altering the alkyl fragment sizes can enable further fine-tuning of the target cation selectivity beyond the ring size effect. For instance, adding two benzene rings (as in DB12C4, DB14C4 and DB18C6 structures in FIG. 6A) or increasing the C2 segment to C3 (as in DB14C4) can drastically shift the binding energy compared to the CE structures that only have one benzene with C₂O ether units. Furthermore, FIG. 6A shows that DB14C4 ether has greater selectivity towards Li⁺ as indicated by its more negative binding energy compared to Na⁺ and K⁺. FIG. 6B shows the trajectories of hydrated Li⁺ transfers between two neighboring DB14C4 molecules under an external force, extracted from MD simulation. Using an explicit water model of MD, which simulates ion transport with presence of water molecules, FIG. 6C shows that DB14C4 is more prone to forming complexes with Li⁺ than with Na⁺ and K⁺ due to the negative binding energy between DB14C4 and Li⁺, whereas the binding energy with Na⁺ and K⁺ are both positive.

The CE-based layer can include multiple different CE-based building blocks, for example, where different target cations are desired to be selectively captures. CE-based building block for each target cation can be incorporated into the CE-based layer. For example, the CE-based layer can include a mixed of polymers, each comprising a different CE-based building block as pendent groups or within the backbone of the polymer. For example, 14-crown-4 ether based building block and 18-crown-6 ether based building block can both be introduced into the CE-based layer to enable selective capture of both Li⁺ and K⁺. Higher concentrations of CE-based building block present in the CE-based layer can promote selectivity of target ions to competitor ions and also enhance transmembrane flux of the target ions. For example, the CE-based building block can be present in the CE-based layer in an amount of about 5 wt % to about 100 wt %. When 100 wt % of CE-based building blocks are introduced into the CE-based layer, the CE-based building blocks can be monomers deposited using known deposition methods, such as electrospray deposition. In this case, the CE-based building blocks are not bound to a polymer.

The CE-based layer can have a thickness, for example, of 5 nm to 500 μm.

The CE-based layer can include a polymer to which a CE-based building block is chemically bound. Chemical bonding of the CE-based building block to the polymer can be accomplished by grafting the CE-based building block to a polymer backbone as pendant groups, or otherwise by bonding the CE-based building block to the polymer backbone, or by incorporating the CE-based building block directly within the polymer backbone. The CE-based layer can have a hydrophilicity that can be tuned to promote the target cation transport from the source water to the membrane surface. The CE-based layer can have channels for ion transport. For example, the CE-based polymer layer can have sub-nanometer openings provided by the intrinsic free volume between entangled polymer chains. These openings within the CE-based polymer layer can provide a pathway for the target cation transport through the CE-based layer to the CEM to facility transfer of the target cations through the membrane into the product stream. For example, the transfer of target cations through the membrane into the product stream can be continuous or substantially continuous.

For example, the CE-based layer can include a modular copolymer with pendant crown ether functionality. For example, the copolymer can be synthesized using vinyl-moiety containing monomers via a free radical polymerization. Selection of monomers in the copolymer can be used to tailor the hydrophilicity of the copolymer. Target cation transport channels can be formed by adjusting conditions and parameters during deposition of the CE-based layer on the CEM. For example, the copolymer can be formed of a monomer or building block that provides hydrophilicity and a monomer or building block that provides functional groups to react with the crown ether. For example, the monomer can include oxirane functional group for attachment of the crown ether through an oxirane-opening reaction. Other monomers with ring-based functional groups are also contemplated herein for functionalization with the crown ether through a ring-opening reaction. The polymer can be formed, for example, of one or more of fluorinated methacrylate, methacrylic acid, poly(ethylene glycol) methyl ether methacrylate, zwitterionic methacrylate, acrylonitrile, glycidyl methacrylate, sodium styrene sulfonate, and vinylbenzyl chloride Examples of fluorinated methacrylates can include 2,2-trifluoroethyl methacrylate, 2,2,3,3,4,4,4-heptafluorobutyl methacrylate, 2,2,3,4,4,4-hexafluorobutyl methacrylate, 2,2,3,3,4,4,5,5-Octafluoropentyl methacrylate, and 2,2,3,3,3-Pentafluoropropyl methacrylate. Examples of zwitterionic methacrylates include phosphobetaine methacrylate, carboxybetaine methacrylate, and sulfobetaine methacrylate.

For example, CE-based layers having the CE pendant groups can be formed of one or more of poly(fluorinated methacrylate-crown ether glycidyl methacrylate), poly[fluorinated methacrylate-crown ether glycidyl methacrylate-oligo(ethylene glycol) methyl ether methacrylate], poly(fluorinated methacrylate-crown ether glycidyl methacrylate-zwitterionic methacrylate), poly(poly(acrylonitrile-crown ether glycidyl methacrylate), poly[(acrylonitrile-crown ether glycidyl methacrylate-oligo(ethylene glycol) methyl ether methacrylate], poly(acrylonitrile-crown ether glycidyl methacrylate-zwitterionic methacrylate), and poly(styrene sulfonate-crown ether methylstyrene).

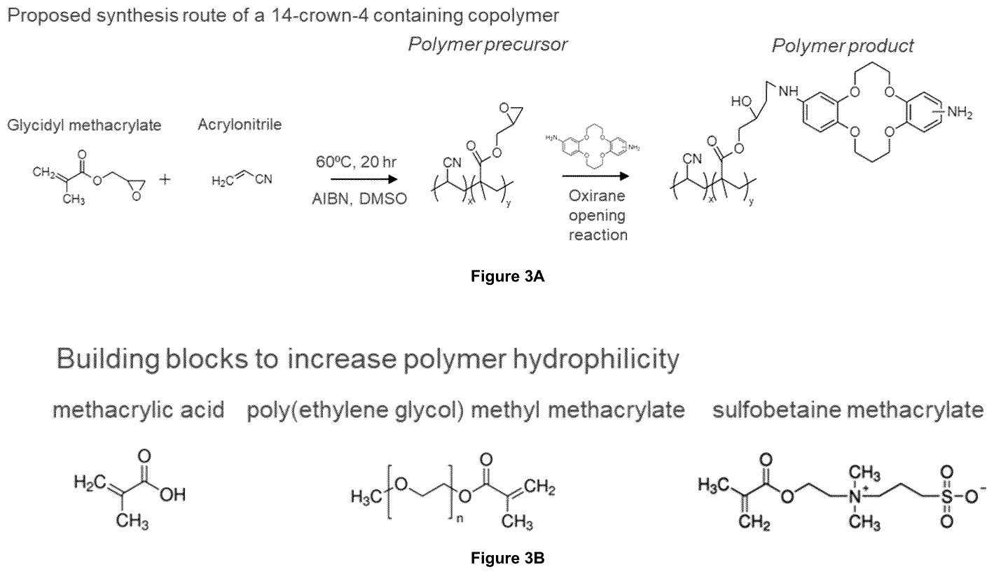

FIG. 3A shows the synthesis pathway of a copolymer formation via free radical polymerization using a di(aminobenzo)-14-crown-4 ether (DAB14C4) functionalizable poly(acrylonitrile-co-glycidyl methacrylate) (P(AN-GMA)) as an example. In this example, the acrylonitrile moiety provides hydrophilicity, and the glycidyl methacrylate moiety provides oxirane functional groups on the polymer, which can react with DAB14C4 through a nucleophilic oxirane-opening reaction to generate DAB14C4 functionalized P(AN-GMA). FIG. 3B illustrates some other contemplated building blocks that can provide the polymer with increased hydrophilicity. For example, polymer hydrophilicity can be adjusted by replacing poly(glycidyl methacrylate) with hydrophilic poly(methacrylic acid) that can react with amino-crown ether via a N-ethyl-N′-(3-(dimethylamino)propyl)carbodiimide/N-hydroxysuccinimide) (EDC/NHS) coupling mechanism, or by introducing a third hydrophilic building block such as poly(ethylene oxide) methyl ether methacrylate or zwitterionic groups (i.e., sulfobetaine methacrylate). Without intending to be bound by theory, it is believed that poly(ethylene glycol) methyl ether methacrylate can be used to increase the hydrophilicity of the polymer and for forming pores of the crown ether polymer layer. Acrylonitrile can be used to increase hydrophilicity, as well.

The synthesis scheme can include free radical polymerization at 40° C. to 120° C. using an initiator such as AIBN in an organic solvent. For example, toluene, DMSO, DMF or other appropriate solvents can be used.

The ring opening reaction can be performed in an organic solvent, such as chloroform, dichloromethane, DMSO, DMF, or other appropriate solvents. The ring opening reaction can be performed at a temperature range of about 50° C. to about 150° C.

The pendant CE-based building blocks can be chemically bound to the polymer through n-alkylation reaction, for example. The reaction can be performed in an organic solvent such as DMSO, DMF or other appropriate solvent at a temperature range of about 50° C. to about 150° C.

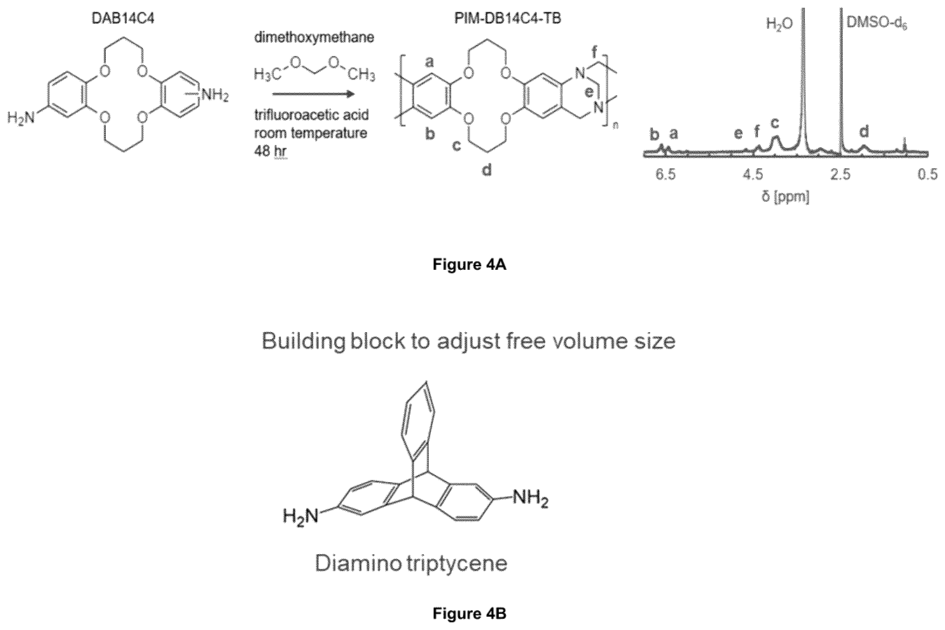

Alternatively, the crown ether-based building block can be incorporated into the polymeric backbone. The polymer can be, for example, a polyimide. Polymers with intrinsic microporosity (PIM polymers) can also provide a suitable backbone structure. Such polymer can form sub-nanometer openings and target cation passing channels through their abundant free volume, which can allow the target cation transport through adjacent CE cavities. Polymer free volume is referred to herein as the free spaces between entangled polymer chains. In forming the CE-based polymer layer having the CE-based building block incorporate into the backbone of the polymer, the free volume can be controlled through selection of the second reactive molecule. Referring to FIG. 4A, for example, a CE-based building block containing PIM can be synthesized via Tröger's base (TB) polymerization, is demonstrated by reacting DAB14C4 with dimethoxymethane. This reaction can be catalyzed by trifluoroacetic acid (TFA). The selection of dimethoxymethane can be useful where the target cation is Li⁺ due to its free volume size (i.e., ˜7.2 Å), which is slightly larger than the dehydrated radius of Li⁺ (˜0.6 Å). FIG. 4A also shows ¹H NMR of the prepared PIM-14C4-TB polymer, where DMSO-d₆ was NMR solvent and H₂O was residual from the polymerization step. Referring to FIG. 4B, the diameter of the free volume can be adjusted using other monomers, such as diamino triptycene, which can function to adjust the target cation transport rate. The substitution of diamino triptycene is believed to increase Li⁺ transport when polymerized with DAB14C4 to form a PIM polymer having the crown ether in the backbone of the polymer.

The CE-based polymer layer having a PIM polymer with the CE-based building block in the backbone can be formed through polymerization of an aromatic diamine monomer and the CE-based building block, for example, an amino-crown ether or derivative thereof. For example, aromatic diamine monomers can be one or more of di- and tri(amino)triptycene (Trip), 1,3,5-tris(4-aminophenyl)benzene (TAPB), 4,4′-diamino-3,3′-dimethyldiphenylmethane (DMDPM), 4,4′-diamine-3,3-dimethyl-biphenyl (DMBP), 4,4′-diaminodiphenylmethane (DADPM), 4,4′-oxydianiline (ODA), o-tolidine (OTD), 2,6(7)-diamino-9,10-dimethyl-9,10-dihydro-9,10-ethanoanthracene (EA), and 5(6),5′(6′)-diamino-3,3,3′,3′-tetramethyl-1,1′-spirobisindane (SBI). For example, the CE-based polymer layer can be formed of one or more of PIM-crown ether-TB, PIM-Trip crown ether-TB, PIM-TAPB crown ether-TB, PIM-DMDPM crown ether-TB, PIM-DMBP crown ether-TB, PIM-DADPM crown ether-TB, PIM-ODA crown ether-TB, PIM-OTD crown ether-TB, PIM-EA crown ether-TB, and PIM-SBI crown ether-TB.

As a still further alternative, the CE-based polymer layer can be formed as a crosslinked polyamide network using interfacial polymerization. This can advantageously allow for formation of the CE-based polymer layer as a polymer directly crosslinked onto the CEM surface. This can be advantageous to provide a very thin CE-based layer. The CE-based polymer layer can be formed, for example, by depositing a solution containing the crown ether dissolved in a first solvent and solution containing one or more aryl chloride monomers dissolved in a second solvent onto the CEM surface. The first and second solvents are immiscible solvents and are selected such that they do not damage or otherwise attack the CEM surface. The interfacial polymerization occurs at the interface between the two immiscible solvents to thereby produce the crown ether polymer layer having a polymer with the CE present in the backbone of the polymer.

The first solvent can be, for example, water, alcohol, DMSO, DMF, acetonitrile, or the like. The second solvent can be, for example, hexane, heptane, or the like.

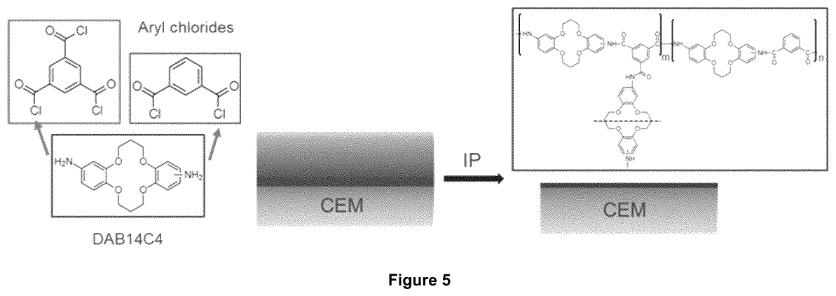

FIG. 5 illustrates an example using isophthaloyl chloride or trimesoyl chloride as the aryl chloride. Suitable aryl chlorides include one or more of isophthaloyl chloride (ITC), trimesoyl chloride (TCM), and terephthaloyl chloride (TCL). The CE-based polymer layer can be formed, for example, of one or more of PA-crown ether ITC, PA-crown ether TMC, PA-crown ether TCL, and PA-crown ether mixed aryl chlorides comprising two or more of ITC, TCM, and TCL.

The advantage of this method is the ability to provide thinner films as compared to those which can be formed through coating or casting methods of an as-formed CE-based polymer layer. For example, the CE-based polymer layer formed by direct crosslinking of the polymer having the CE in the backbone onto the CEM can have a thickness of about 5 nm to about 50 μm.

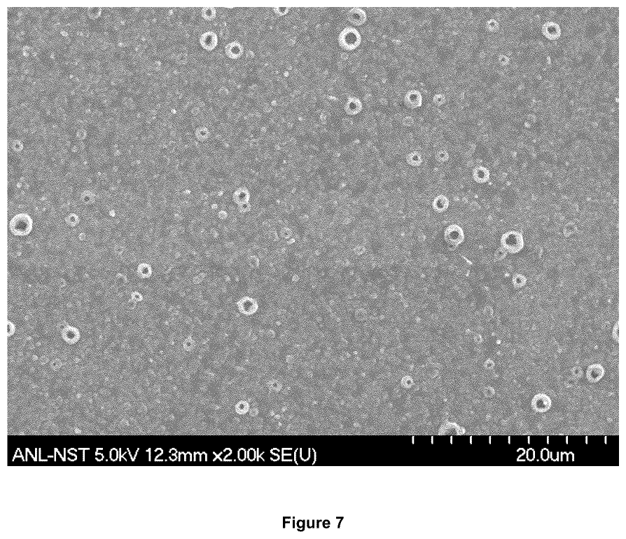

With the exception of the method of forming the crown ether polymer layer through direct crosslinking onto the CEM, the crown ether polymer layer composition once formed can be deposited onto the CEM to form the CE-based layer. Various deposition methods can be used. For example, the CE-based layer can be coated by dip-coating, spin-coating, electro-spraying, gravure coating, slot-die coating, blade coating, sol gel casting, drop casting, screen printing, ink jet printing, aerosol jet printing, flexographic printing, or other similar techniques. In an example of electrospray coating, DB14C4 monomers are dissolved in chloroform to form a solution with 0.3 wt. % DB14C4 concentration. This solution is used for electrospray, where the DB14C4 chloroform solution is sprayed onto a CEM under an electric field of 8.5 kV at an injection rate of 0.25 mL/hr. The distance between the spray nozzles and CEM membrane is about 2.5 inches. After 30 minutes of spraying, a thin film of DB14C4 was formed, as shown in a SEM image in FIG. 7. For scalable manufacturing, continuous deposition via roll-to-roll or sheet-by-sheet manufacturing can be used with deposition.

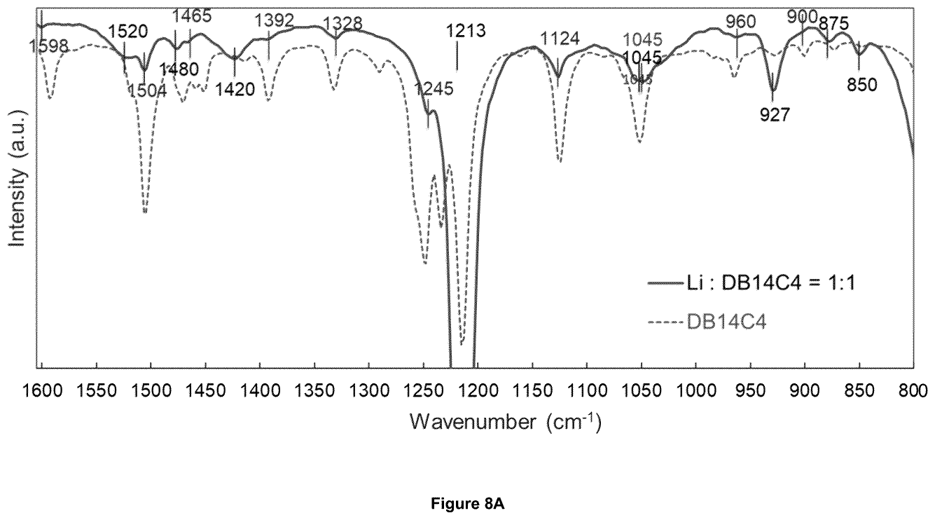

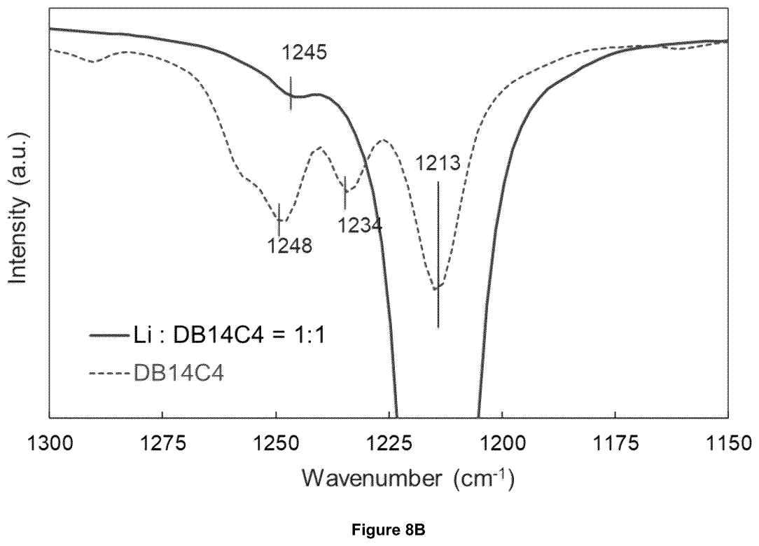

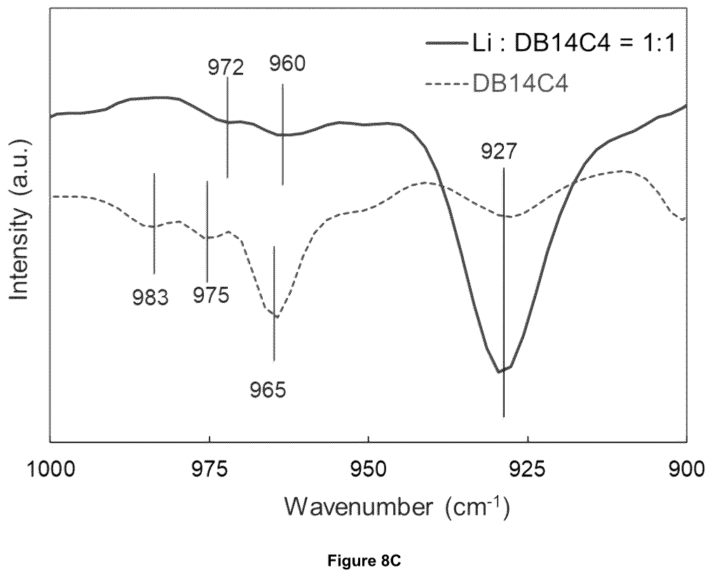

FIG. 8A shows comparative FTIR spectra of pure DB14C4 ether and DB14C4 with lithium. Both samples were dissolved in chloroform. Peaks associated with DB14C4 ether are labeled with light color fonts, while peaks associated with chloroform were labeled with dark color fonts. Enlarged regions of FIG. 8A were shown in FIG. 8B in the range of 1300-1150 cm⁻¹ and FIG. 8C in the range of 1000-900 cm⁻¹. Shift of the C—O—C band to a lower frequency region for the DB14C4-Li sample as compared to pure DB14C4 indicates the formation of DB14C4-Li complex.

CEMs are often used in electrochemical reactions for cation transport. During an electrodialysis process, CEMs bearing functional groups allow cation transfer while hindering permeation of anions. Membranes of the disclosure incorporate a CEM to facilitate transport of the cation from the source liquid to the product stream. Any known CEM can be used. The CEM can have a thickness of about 10 μm to about 500 μm. Various CEM membranes are sold commercially and can be used in the membrane disclosed herein. For example, CEM membranes having the brand/tradename NAFION, AQUIVON, FUMASEP, FUMAPEM, NEOSEPTA, PCA, or RALEX can be used in the membranes of the disclosure.

The source liquid can be any one or more of seawater, industrial processed wastewater, municipal wastewater, agriculture wastewater, geothermal brines, gas or oil field processed waters, waters generated from battery, electronics, magnet, fuel cell, water electrolyzer, and/or other device recycling.

The product stream can be a liquid stream that is a low concentration salt solution of a salt having the target cation(s) to be recovered.

### Aspects

Aspect 1. A membrane for selective separation of one or more target cations from a source liquid containing the one or more target cations and one or more competing ionic species, comprising:
a crown ether based layer disposed on a cation exchange membrane, wherein:
the crown ether based layer comprises one or more crown ether-based building block capable of selectively binding the one or more target cations, and
the crown ether-based building block is present in the crown ether based layer in an amount of about 5 wt % to about 100 wt %.
Aspect 2. The membrane of any one of the preceding aspects, wherein the crown ether based layer comprises the crown ether-based building block chemically bound to a polymer.
Aspect 3. The membrane of aspect 2, wherein chemically bound includes grafting crown ether-based building block onto a backbone of the polymer as a pendant group. The polymer is a random copolymer comprising an oxirane functional group. Grafting performs an oxirane-opening reaction.
Aspect 4. The membrane of aspect 2, wherein the polymer comprises one or more monomers selected from fluorinated methacrylate, acrylonitrile, sodium styrene sulfonate, styrene, zwitterionic methacrylate, poly(ethylene glycol) methyl ether methacrylate, glycidyl methacrylate, methyl methacrylic acid, vinylbenzyl chloride, derivatives thereof.
Aspect 5. The membrane of aspect 2, wherein the fluorinated methacrylate is one or more of 2,2-trifluoroethyl methacrylate, 2,2,3,3,4,4,4-heptafluorobutyl methacrylate, 2,2,3,4,4,4-hexafluorobutyl methacrylate, 2,2,3,3,4,4,5,5-Octafluoropentyl methacrylate, and 2,2,3,3,3-Pentafluoropropyl methacrylate.
Aspect 6. The membrane of aspect 2, wherein the zwitterionic methacrylate is one or more of phosphobetaine methacrylate, carboxybetaine methacrylate, and sulfobetaine methacrylate.
Aspect 7. The membrane of any one of aspects 1 to 6, wherein the crown ether based building block is an amino-crown ether, and the amino-crown ether is one or more of 4-aminobenzo-12-crown-4, aminobenzo-14-crown-4 ether, di(aminobenzo)-14-crown-4 ether, aminobenzo-15-crown-5 ether, di(aminobenzo)-15-crown-5 ether, aminobenzo-18-crown-6 ether, di(aminobenzo)-18-crown-6 ether, aminoben-24-crown-8 ether, and di(aminobenzo)-24-crown-8 ether, and derivatives thereof.
Aspect 8. The membrane of any one of aspects 1 to 8, wherein the crown ether based layer comprises crown ether polymers formed of one or more of poly(fluorinated methacrylate-crown ether glycidyl methacrylate), poly[fluorinated methacrylate-crown ether glycidyl methacrylate-oligo(ethylene glycol) methyl ether methacrylate], poly(fluorinated methacrylate-crown ether glycidyl methacrylate-zwitterionic methacrylate), poly(poly(acrylonitrile-crown ether glycidyl methacrylate), poly[(acrylonitrile-crown ether glycidyl methacrylate-oligo(ethylene glycol) methyl ether methacrylate], poly(acrylonitrile-crown ether glycidyl methacrylate-zwitterionic methacrylate), and poly(styrene sulfonate-crown ether methylstyrene).
Aspect 9. The membrane of aspect 2, wherein the crown ether-based building block is polymerized with one or more other non-crown ether building blocks to form the polymer having the crown ether-based building block incorporated into a backbone of the polymer.
Aspect 10. The membrane of aspect 9, wherein the polymer is a polymer with intrinsic microporosity (PIM).
Aspect 11. The membrane of aspect 10, wherein the polymer with intrinsic porosity comprises aromatic diamine monomers and the crown ether-based building block comprises an amino-crown ether or derivative thereof.
Aspect 12. The membrane of aspect 11, wherein the amino-crown ether is di(aminobenzo)-crown ether.
Aspect 13. The membrane of aspect 12, wherein the di(aminobenzo) crown ether is one or more of di(aminobenzo)-14-crown-4 ether, di(aminobenzo)-15-crown-5 ether, di(aminobenzo)-18-crown-6 ether, and di(aminobenzo)-24-crown-8 ether, and derivatives thereof.
Aspect 14. The membrane of any one of aspects 10 to 14, wherein the non-crown ether building block is aromatic diamine monomers, which include one or more of di- and tri(amino)triptycene (Trip), 1,3,5-tris(4-aminophenyl)benzene (TAPB), 4,4′-diamino-3,3′-dimethyldiphenylmethane (DMDPM), 4,4′-diamine-3,3′-dimethyl-biphenyl (DMBP), 4,4′-diaminodiphenylmethane (DADPM), 4,4′-oxydianiline (ODA), o-tolidine (OTD), 2,6(7)-diamino-9,10-dimethyl-9,10-dihydro-9,10-ethanoanthracene (EA), and 5(6),5′(6′)-diamino-3,3,3′,3′-tetramethyl-1,1′-spirobisindane (SBI).
Aspect 15. The membrane of any one of aspects 1 to 14, wherein the crown ether based layer is formed of one or more of PIM-crown ether-TB, PIM-Trip crown ether-TB, PIM-TAPB crown ether-TB, PIM-DMDPM crown ether-TB, PIM-DMBP crown ether-TB, PIM-DADPM crown ether-TB, PIM-ODA crown ether-TB, PIM-OTD crown ether-TB, PIM-EA crown ether-TB, and PIM-SBI crown ether-TB.
Aspect 16. The membrane of aspect 2, wherein the crown ether based layer is directly crosslinked with another monomer to form a crown ether containing polyamide (PA) on the surface of CEM.
Aspect 17. The membrane of aspect 16, wherein the crown ether-based building block is di(aminobenzo)-crown ether or a derivative thereof and the second monomer further comprises one or more aryl chloride monomers.
Aspect 18. The membrane of aspect 17, wherein the di(aminobenzo)-crown ether is one or more of di(aminobenzo)-14-crown-4 ether, di(aminobenzo)-15-crown-5 ether, di(aminobenzo)-18-crown-6 ether, di(aminobenzo)-24-crown-8 ether, and derivatives thereof.
Aspect 19. The membrane of aspect 17 or 18, wherein the one or more aryl chloride monomers are one or more of isophthaloyl chloride (ITC), trimesoyl chloride (TCM), and terephthaloyl chloride (TCL).
Aspect 20. The membrane of any one of aspects 1 to 19, wherein the crown ether based layer is formed of one or more of PA-crown ether ITC, PA-crown ether TMC, PA-crown ether TCL, and PA-crown ether mixed aryl chlorides comprising two or more of ITC, TCM, and TCL.
Aspect 21. The membrane of any one of the preceding aspects, wherein the crown ether layer has a thickness of 5 nm to 500 μm.
Aspect 22. The membrane of any one of the preceding aspects, wherein the target cation comprises an alkali metal cation.
Aspect 23. The membrane of aspect 22, wherein the alkali metal cation is one or more of Li⁺, Na⁺, K⁺, Rb⁺, and Cs⁺.
Aspect 24. The membrane of any one of the preceding aspects, wherein the target cation comprises transition metal ions selected from one or more of Ni²⁺, Co²⁺, Fe²⁺, or rare earth metal ions selected from one or more of Nd³⁺, Sm³⁺, Dy³⁺, Tb³⁺, Ho³⁺, Gd³⁺, or other cations selected from one or more of NH₄₊, Ag⁺, Au³⁺, Pt²⁺, Pt⁴⁺, Ir²⁺, Ir⁴⁺, Ca²⁺, Sr²⁺, Ba²⁺, Hg²⁺, and Pb²⁺.
Aspect 25. The membrane of any one of the preceding aspects, wherein the one or more competing ionic species comprises one or more monovalent or divalent cations.
Aspect 26. The membrane of any one of the preceding aspects, wherein target cation is Li⁺ and the one or more competing ionic species comprises Na⁺ and/or Mg²⁺ and/or K⁺.
Aspect 27. The membrane of any one of the preceding aspects, wherein the crown ether-based building block is one or more of 14-crown-4 ether, 12-crown-4 ether, 15-crown-5 ether, 18-crown-6 ether, 24-crown-8 ether, aza-crown ether, and derivatives thereof.
Aspect 28. The membrane of any one of the preceding aspects, wherein the crown ether-based building block has a side group selected from one or more of methyl (—CH₃), hydroxyl (—OH), primary amine (—NH₂), carboxylic acid (—COOH), and alkylate (—CH(CH₂)ₙCH₃).
Aspect 29. The membrane of any one of the preceding aspects, wherein the crown ether polymer layer has an average “pore” size of about 0.1 nm to about 1 nm.
Aspect 30. The membrane of any one of the preceding aspects, wherein the cation exchange membrane has a thickness of about 10 μm to about 500 μm.
Aspect 31. The membrane of any one of the preceding aspects, wherein the cation exchange membrane is one or more of Nafion, Aquivion, Fumasep, Fumapem, Neosetpa, PCA, and Ralex.
Aspect 32. A system for selective separation of one or more target cations from a source liquid containing the one or more target cation and one or more competing ionic species, comprising:
an anode,
a cathode,
a first membrane for target cation separation, the first membrane for target cation separation being the membrane of any one of the preceding aspects interposed between the anode and the cathode, the membrane having a cathode facing side and an oppositely disposed anode facing side, wherein the crown ether based layer is at the anode facing side and the cation exchange membrane of the first membrane for target cation separation is at the cathode facing side,
a first anion exchange membrane arrange between the cathode and the at least one membrane for separation, wherein:
upon application of an electric field, the bound target cations are transported through the crown ether polymer layer and the cation exchange membrane into a product stream.
Aspect 33. The system of aspect 32, further comprising a second anion exchange membrane arranged between the first membrane for target cation separation and the cathode, and a first cation exchange membrane arranged between the second anion exchange membrane and the cathode.
Aspect 34. The system of aspect 32, wherein the system is a multiple cell system comprising at least first and second cell arranged between the anode and the cathode,
the first cell comprising the first membrane for target cation separation, and the first anion exchange membrane,
the second cell comprising a second membrane for target cation separation and a second anion exchange membrane, the second membrane for target cation separation being arranged between the first and second anion exchange membranes;
a third anion exchange membrane and a cation exchange membrane arranged between the second cell and the cathode, the cation exchange membrane being disposed between the third anion exchange membrane and the cathode.
Aspect 35. A system for selective separation of one or more target cations from a source liquid containing the one or more target cation and one or more competing ionic species, comprising:
an anode;
a cathode;
one or more cells arranged between the cathode and anode, each of the one or more cells comprising an anion exchange membrane and a membrane for separation of the one or more target cations in accordance with any one of aspects 1 to 32, the membrane having a cathode facing side and an oppositely disposed anode facing side, wherein the crown ether based layer is at the anode facing side and the anion exchange membrane is arranged between the anode facing side and the anode;
a terminal anion exchange membrane arranged between the last one of the one or more cells at a cathode end of the system and the cathode; and
a terminal cation exchange membrane arranged between the terminal anion exchange membrane and the cathode,
wherein:
upon application of an electric field, the bound target cations are transported through the crown ether polymer layer and the cation exchange membrane into a product stream.
Aspect 36. The method of aspect 35, wherein the system comprises two or more cells.
Aspect 37. A method for selective separation of one or more target cations from a source liquid containing the target cations and one or more competing ionic species, comprising:
flowing the source liquid through the system of any one of aspects 32 to 36, between an anion exchange membrane facing anode and the crown ether based layer on the anode facing side of the membrane for target cation separation;
flowing a product stream through the system, between the cation exchange membrane on the cathode facing side of the membrane for target cation separation and the first anion exchange membrane; and
applying an electric field between the anode and the cathode,
wherein one or more target cations in the source liquid are selectively bound by the crown ether based layer and transport through the crown ether based layer and the cation exchange membrane of the membrane for target cation separation into the product stream for recovery of the one or more target cations.
Aspect 38. The method of aspect 37, wherein the applied current density of about 3 mA cm⁻² to about 75 mA cm⁻².
Aspect 39. The method of aspect 37 or 38, wherein the source liquid is flowed at a rate of about 0.1 liters per hour to about 150 liters per hour.
Aspect 40. The method of any one of aspects 37 to 39, wherein the product stream is flowed at a rate of about 0.1 liters per hour to about 150 liters per hour.
Aspect 41. The method of any one of aspects 37 to 40, wherein the source liquid is one or more of seawater, brine, industry produced water, agriculture wastewater, geothermal brines, gas or oil field produced water, and water generated during device and component recycling.
Aspect 42. A method of making the membrane of any one of aspects 1 to 31, comprising:
applying a crown ether based layer onto a cation exchange membrane, wherein the crown ether based layer comprises crown ether-based monomers or a polymer comprising a crown ether-based building block, wherein the crown ether-based building block is capable of selectively binding the target cation.
Aspect 43. The method of aspect 42, further comprising forming the crown ether based layer using the materials and methods in the preceding aspects.
Aspect 44. The method of any one of aspects 42 or 43, wherein applying a crown ether polymer layer onto the cation exchange membrane comprises coating the cation exchange membrane with the crown ether based layer or casting the crown ether based layer onto the cation exchange membrane.
Aspect 45. The method of aspect 44, comprising coating or casting by slot-die coating, dip coating, doctor blading, spin coating, drop casting, roll casting, gravure coating, sol gel casting, screen printing, ink jet printing, aerosol jet printing, flexographic printing, electrospray, or combinations thereof.
Aspect 46. The method of aspect 42 to 45, wherein the crown ether based layer has a thickness of about 5 nm to about 500 μm.
Aspect 47. The method of aspect 42, wherein applying the crown ether based layer onto the cation exchange membrane comprises:
depositing a crown ether-based monomer solution onto the cation exchange membrane, wherein the crown ether-based monomer solution comprising the crown ether building block dissolved in a first solvent; and
depositing a building block solution onto the cation exchange membrane having the crown ether-based monomer solution, wherein the building block solution comprises one or more aryl chloride monomers dissolved in a second solvent,
wherein the first and second solvents are immiscible and interfacial polymerization of the crown ether present in the crown ether solution and the one or more aryl chloride monomers present in the monomer solution occurs at an interface between the two immiscible solutions to thereby directly crosslink a polymer having a polymer backbone comprising the crown ether-based building block and the one or more aryl chloride monomers to the cation exchange membrane.
Aspect 48. The method of aspect 47, wherein the one or more aryl chloride monomers comprises one or more of isophthaloyl chloride (ITC), trimesoyl chloride (TMC), and terephthaloyl chloride (TCL) and the monomer comprises one di(aminobenzo)-crown ether from di(aminobenzo)-14-crown-4 ether, di(aminobenzo)-15-crown-5 ether, di(aminobenzo)-18-crown-6 ether, and di(aminobenzo)-24-crown-8 ether, and derivatives thereof.
Aspect 49. The method of aspect 47 or 48, wherein the first solvent is water, alcohol, DMSO, DMF, or acetonitrile.
Aspect 50. The method of any one of aspects 47 to 49, wherein the second solvent is hexane or heptane.
Aspect 51. The method of any one of aspects 47 to 50, wherein the crown ether polymer layer has a thickness of about 5 nm to about 50 μm.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A membrane for selective separation of one or more target cations from a source liquid containing the one or more target cations and one or more competing ionic species, comprising:
a crown ether based layer disposed on a cation exchange membrane, wherein:
the crown ether based layer comprises one or more crown ether-based building block capable of selectively binding the one or more target cations, and
the crown ether-based building block is present in the crown ether based layer in an amount of about 5 wt % to about 100 wt %.

2. The membrane of claim 1, wherein the crown ether-based building blocks comprises crown ether-containing monomers and/or crown ether containing polymers, wherein the crown ether-based building blocks are chemically bound to a polymer by grafting, or the crown ether-based building blocks are incorporated into the backbone of the polymer by polymerization with one or more non-crown ether building blocks, or the crown ether-based building blocks are crosslinked with a second monomer to form a crown ether-based polyamide layer directly on the surface of a cation exchange membrane.

3. The membrane of claim 2, wherein the polymer used in grafting comprises one or more monomers selected from fluorinated methacrylate, acrylonitrile, sodium styrene sulfonate, styrene, zwitterionic methacrylate, poly(ethylene glycol) methyl ether methacrylate, glycidyl methacrylate, methyl methacrylic acid, vinylbenzyl chloride, derivatives thereof.

4. The membrane of claim 3, wherein the fluorinated methacrylate is one or more of 2,2-trifluoroethyl methacrylate, 2,2,3,3,4,4,4-heptafluorobutyl methacrylate, 2,2,3,4,4,4-hexafluorobutyl methacrylate, 2,2,3,3,4,4,5,5-Octafluoropentyl methacrylate, and 2,2,3,3,3-Pentafluoropropyl methacrylate. The zwitterionic methacrylate is one or more of phosphobetaine methacrylate, carboxybetaine methacrylate, and sulfobetaine methacrylate.

5. The membrane of claim 1, wherein the crown ether-based building block comprises one or more of amino derivatives of 12-crown-4 ether, 15-crown-5 ether, 18-crown-6 ether, 24-crown-8 ether, aza crown ether, and derivatives thereof.

6. The membrane of claim 2, wherein the crown ether based building blocks are incorporated into the backbone of a polymer, the polymer is a polymer with intrinsic microporosity (PIM) comprising aromatic diamine monomers, and the crown ether-based building block comprises a diamino-crown ether or derivative thereof.

7. The membrane of claim 6, wherein the aromatic diamine monomers comprise one or more of di- and tri(amino)triptycene (Trip), 1,3,5-tris(4-aminophenyl)benzene (TAPB), 4,4′-diamino-3,3′-dimethyldiphenylmethane (DMDPM), 4,4′-diamine-3,3′-dimethyl-biphenyl (DMBP), 4,4′-diaminodiphenylmethane (DADPM), 4,4′-oxydianiline (ODA), o-tolidine (OTD), 2,6(7)-diamino-9,10-dimethyl-9,10-dihydro-9,10-ethanoanthracene (EA), and 5(6),5′(6′)-diamino-3,3,3′,3′-tetramethyl-1,1′-spirobisindane (SBI).

8. The membrane of claim 2, wherein the crown ether based layer is deposited on a cation exchange membrane through crosslinking with the second monomer to form the crown ether containing polyamide, and the second monomer further comprises one or more aryl chloride monomers selected from one or more of isophthaloyl chloride (ITC), trimesoyl chloride (TCM), and terephthaloyl chloride (TCL), and the crown ether based building block comprise one or more di(amino)-crown ethers and derivatives thereof.

9. The membrane of claim 1, wherein the crown ether layer has a thickness of 5 nm to 500 μm.

10. The membrane of claim 1, wherein the one or more target cations are one or more of Li⁺, Na⁺, K⁺, Rb⁺, Cs⁺, Ni²⁺, Co²⁺, Fe²⁺, Nd³⁺, Sm³⁺, Dy³⁺, Tb³⁺, Ho³⁺, Gd³⁺, NH₄₊, Ag⁺, Au³⁺, Pt²⁺, Pt⁴⁺, Ir²⁺, Ir⁴⁺, Ca²⁺, Sr²⁺, Ba²⁺, Hg²⁺, and Pb²⁺.

11. The membrane of claim 1, wherein the or more target cations is Li⁺ and the one or more competing ionic species comprises Na⁺ and/or Mg²⁺ and/or K⁺.

12. The membrane of claim 1, wherein the crown ether-based building block has a side group selected from one or more of methyl (—CH₃), hydroxyl (—OH), primary amine (—NH₂), carboxylic acid (—COOH), and alkylate (—CH(CH₂)ₙCH₃).

13. The membrane of claim 1, wherein the crown ether-based layer has an average opening size of about 0.1 nm to about 1 nm.

14. A system for selective separation of one or more target cations from a source liquid containing the one or more target cations and one or more competing ionic species, comprising:
an anode,
a cathode,
a first membrane for target cation separation, the first membrane for target cation separation being the membrane of claim 1 interposed between the anode and the cathode, the membrane having a cathode facing side and an oppositely disposed anode facing side, wherein the crown ether-based layer is at the anode facing side and the cation exchange membrane of the first membrane for target cation separation is at the cathode facing side,
an anion exchange membrane arranged between the cathode and the at least one membrane for separation, wherein:
upon application of an electric field, the bound target cations are transported through the crown ether polymer layer and the cation exchange membrane into a product stream.

15. A system for selective separation of one or more target cations from a source liquid containing the one or more target cations and one or more competing ionic species, comprising:
an anode;
a cathode;
one or more cells arranged between the cathode and anode, each of the one or more cells comprising an anion exchange membrane and a membrane for separation of the one or more target cations in accordance with claim 1, the membrane having a cathode facing side and an oppositely disposed anode facing side, wherein the crown ether based layer is at the anode facing side and the anion exchange membrane is arranged between the anode facing side and the anode;
a terminal anion exchange membrane arranged between the last one of the one or more cells at a cathode end of the system and the cathode; and
a terminal cation exchange membrane arranged between the terminal anion exchange membrane and the cathode,
wherein:
upon application of an electric field, the bound target cations are transported through the crown ether polymer layer and the cation exchange membrane into a product stream.

16. The method of claim 15, wherein the system comprises two or more cells.

17. A method for selective separation of one or more target cations from a source liquid containing the target cations and one or more competing ionic species, comprising:
flowing the source liquid through the system of claim 15, between an anion exchange membrane facing anode and the crown ether based layer on the anode facing side of the membrane for target cation separation;
flowing a product stream through the system, between the cation exchange membrane on the cathode facing side of the membrane for target cation separation and the first anion exchange membrane; and
applying an electric field between the anode and the cathode,
wherein one or more target cations in the source liquid are selectively bound by the crown ether based layer and transport through the crown ether based layer and the cation exchange membrane of the membrane for target cation separation into the product stream for recovery of the one or more target cations.

18. The method of claim 17, wherein the source liquid is flowed at a rate of about 0.1 liters per hour to about 150 liters per hour and/or the product stream is flowed at a rate of about 0.1 liters per hour to about 150 liters per hour.

19. A method of making the membrane of claim 1, comprising:
applying a crown ether based layer onto a cation exchange membrane, wherein the crown ether based layer comprises crown ether-based monomers or polymers capable of selectively binding the target cation.

20. The method of claim 19, wherein the crown ether based layer is applied onto the cation exchange membrane by coating, or casting, or layer-by-layer interfacial polymerization.
